(19) United States
(12) Patent Application Publication
(10) Pub. No.: US 2013/0213486 A1
(43) Pub. Date: Aug. 22, 2013

(54) COLUMN PRESSURE REGULATION SYSTEM AND METHOD

(71) Applicant: MICHAEL BRANDT, Lincolnshire, IL (US)

(72) Inventor: MICHAEL BRANDT, Lincolnshire, IL (US)

(21) Appl. No.: 13/764,342

(22) Filed: Feb. 11, 2013

Related U.S. Application Data
(60) Provisional application No. 61/597,008, filed on Feb. 9, 2012.

(51) Int. Cl. C07B 61/00

(52) U.S. Cl. CPC C07B 61/00
USPC 137/12; 137/565.13

(57) ABSTRACT

A system for regulating a pressure of a piston on a bed in a flow through column system, where the flow through column system includes a piston pressure chamber in communication with the piston and an inlet line and an outlet line in communication with the bed. A pump has an inlet in communication with a supply of hydraulic fluid. A forward pressure reference communicates with the inlet line. A forward pressure regulator has a reference inlet in communication with the forward pressure reference and an inlet in communication with the pump. A switching valve communicates with the piston pressure chamber, and also has a inlet in communication with the outlet of the forward pressure regulator. A back pressure reference communicates with the outlet line. A back pressure regulator has an inlet in communication with the outlet of the switching valve, a reference inlet in communication with the back pressure reference and an outlet in communication with the supply of hydraulic fluid. The switching valve may be manipulated so that a pressure in the piston pressure chamber is controlled by either the forward pressure regulator or the back pressure regulator.

### CLAIM OF PRIORITY

This application claims priority to U.S. Provisional Patent Application No. 61/597,008, filed Feb. 9, 2012, the contents of which are hereby incorporated by reference.

### BACKGROUND

Synthesis of complex molecules through successive addition of building block molecules enables construction of molecular chains and structures which have specific (desirable) sequence, configuration, functionality, properties, etc. The manufacture (synthesis) of these complex molecules may begin with the first building block molecule(s) (or receptive site(s) for the first building block molecule(s)) attached to the surface of very small particle(s) or “bead(s)” which may be porous etc. (substrate).

The beads used in complex molecule synthesis are intentionally small and spherical so as to take advantage of the very large surface area (to volume ratio) which is presented when many are packed into a (flow through) vessel or column. Solvents and reagents in liquid form are directed through the column to accomplish the complex molecule synthesis. The properties (composition, material, structure, etc.) of the beads are a) intentionally receptive to attachment(s) of the first building block molecule(s), b) robust through the various (repetitive) chemical steps of the synthesis (able to hold on to the first building block molecule while a chain or structure is built upon it) and c) able to release the first building block molecule (with complex synthesis molecule attached) when called to do so by chemical manipulation or other means.

For the sake of efficiency, the arrangement of beads inside the vessel or reactor should be as homogeneous as possible. More specifically, the beads preferably have the same size and shape so they can be packed tightly and in a specific formation. The shape of each bead should always remain spherical in order to minimize contact surfaces between beads; as such contact surfaces are not available for first building block attachment, and to maximize the shape and volume of the interstitial void(s) (space) between beads. These voids serve as conduits for flow of liquid (solvents, reagents, wash, etc.) around and past the beads during synthesis steps. The beads are packed as tightly as possible as need be to approach homogeny and maximum efficiency.

The beads are exposed to harshly variable environments (solvents, reagents, compression) during the synthesis steps including a transition between solvents (such as acetonitrile to toluene and back) which reversibly alters the density of the material causing the bead to swell or contract (the latter when switching from toluene to acetonitrile). The synthesis, being a series of repetitive steps, will put the beads through many swell and contract cycles. Also, the synthesis itself is adding mass (thus volume) to the bead with each successive attachment of building block molecule(s) (growth). The bead grows incrementally larger with each step taken and cycles through swell and contract cycle(s) within each step.

The state of the art in large-scale synthesis is to manage these beads in a flow through vessel (or column) with a piston dynamically actuated to consolidate the bed. In dynamic axial compression (“DAC”), an adjustable position piston head is used to consolidate the substrate particulate material, usually of a size between 60 and 100 microns, within the column (often called a “reactor” in synthesis). The piston head is dynamically moved by means of pneumatic or hydraulic pressure. The force on the piston may be applied externally of the column via a rod and cylinder or internally by pressurizing the column on one side of the piston.

For a DAC column to provide support for the bed throughout the entire synthesis, it must be able to accommodate fluctuations in the substrate bed volume which occur at different rates and magnitudes during various steps of the synthesis. Accumulative growth of the substrate bed volume occurs with the successive addition of building block molecules on a per cycle basis and may be slow and small in magnitude. In contrast, swelling and contracting of the bead(s) occurs during various solvent transition step(s) and may be fast and large in magnitude.

Both the accumulative growth of the substrate volume and the swelling of the beads during a solvent transition to toluene may cause the beads to push into and plug the bed support of the column (frit or mesh). Corollary to this, contracting of the beads during a solvent transition step to acetonitrile may allow the beads to fluidize or channel which reduces the efficiency of the column.

A need therefore exists for a system and method that can accommodate both the slow and small in magnitude accumulative growth of the substrate bed volume that occurs with the successive addition of building block molecules and the fast and large in magnitude swelling and contracting of the bead(s) that occur during solvent transition steps.

### BRIEF DESCRIPTION OF THE DRAWINGS

FIG. 1 is a schematic illustrating an embodiment of the column pressure regulation and piston movement system and method of the invention.

### DETAILED DESCRIPTION OF EMBODIMENTS

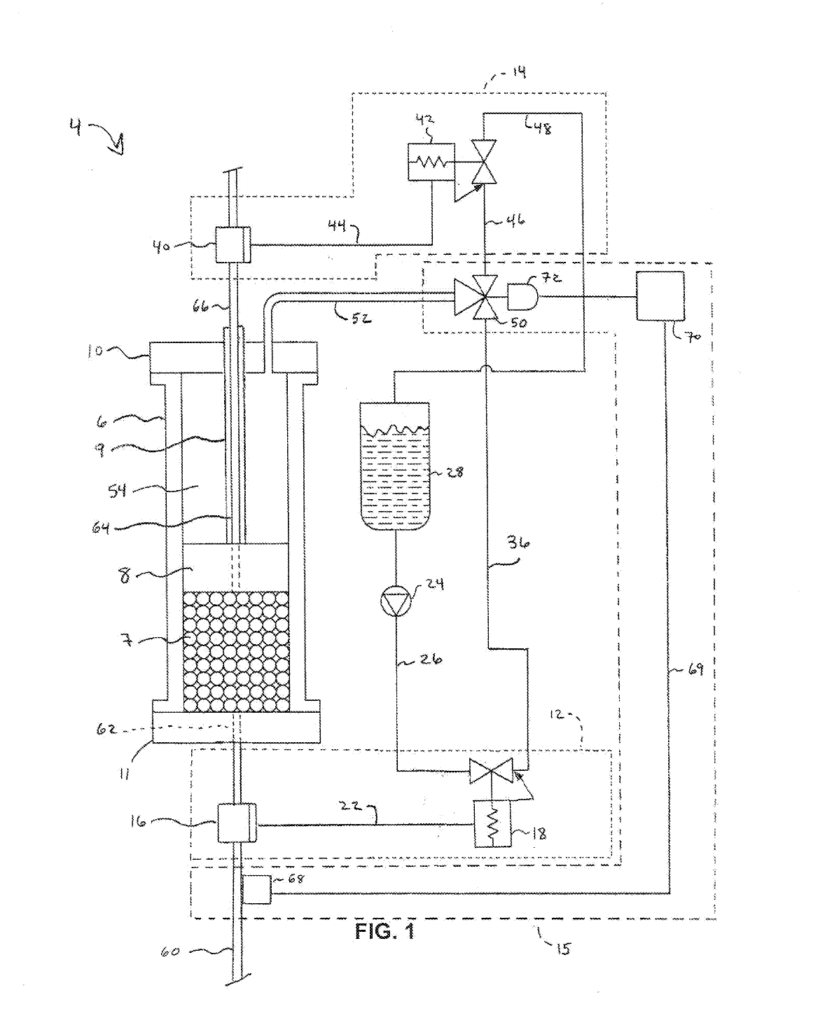

An embodiment of the column pressure regulation system and method of the present invention is indicated in general at 4 in FIG. 1. The system includes a column (used as a reactor) having a housing 6 with top plate 10 and bottom plate 11 within which a sliding piston is positioned. The piston includes a piston head 8 and a piston rod 9 that constrains a volume 54 within the column wherein fluid pressure is applied (or released) to the back side of the piston head to cause movement of the piston to consolidate a substrate bed of beads 7.

The embodiment of the system of FIG. 1 also includes a forward pressure regulation subsystem, indicated by dashed box 12, and a back pressure regulation subsystem, indicated by dashed box 14.

The forward pressure regulation subsystem 12 features a first column or forward pressure reference 16 which communicates with a reference inlet of a dome and spring loaded forward pressure regulator 18 via line 22. The outlet of the forward pressure regulator communicates with an inlet of switching valve 50 via line 36. The inlet of the forward pressure regulator communicates with the outlet of a pump 24 (or other pressure source) via line 26. A supply of fluid (and reservoir for return of fluid) 28 communicates with the inlet of the pump.

The back pressure regulation subsystem 14 features a second column or back pressure reference 40 which communicates with a reference inlet of a dome and spring loaded back pressure regulator 42 via line 44. The inlet of the back pressure regulator 42 communicates with an outlet of the switching valve 50 via line 46. The outlet of the back pressure regulator communicates with fluid reservoir 28 via line 48.

The switching valve subsystem 15 features an automated 3-way switching valve 50 which is provided with an actuator 72 that communicates with a logic and pressure monitoring system controller 70. The logic and pressure monitoring controller 70 communicates with an inlet column pressure sensor 68 via wire 69. The switching valve 50 communicates with lines 36 and 46 as well as a line 52 which communicates with the piston pressure chamber 54 of the column. The piston pressure chamber 54 may alternatively take the form of an external pressure cylinder, as illustrated in FIG. 2 of U.S. patent application Ser. No. 12/765,498 to Brandt et al. The contents of U.S. patent application Ser. No. 12/765,498 to Brandt et al. are hereby incorporated by reference.

An inlet line 60 communicates with the inlet column pressure sensor 68, the forward pressure regulator pressure reference 16 and an inlet passage 62 of the column, while an outlet passage 64 passes through the piston head 8 and piston rod 9 of the column and then connects to outlet line 66, which communicates with back pressure regulator pressure reference 40. Of course the liquid flow through the column may be reversed, so that 62 becomes the outlet passage and 64 becomes the inlet passage.

Operation of the system of FIG. 1 in accordance with an embodiment of the method of the invention will now be described using acetonitrile and toluene as the solvents. One skilled in the art can easily understand that the system and method may be used with other reagents as solvents as variations in synthesis steps may require. Back pressure regulation subsystem 14 is typically used to control the pressure in piston chamber 54, but the system of FIG. 1 changes such over to the forward pressure regulation subsystem 12 when the beads of bed 7 contract, such as when the solvent changes to acetonitrile, as described below.

During various synthesis steps where acetonitrile is used as the solvent and the beads of bed 7 contract, switching valve 50 is configured under the direction of switching valve subsystem 15 as explained below, so that lines 52 and 36 are in communication with one another and lines 44, 46 and 48 are inactive. Pressure regulated hydraulic fluid delivered by spring and dome loaded forward pressure regulator 18 is then selectively provided to the piston pressure chamber 54 from the hydraulic fluid supply 28 via pump 24 and lines 26, 36 and 52 to compress the bed 7. Switching of valve 50 to this configuration may be timed to coordinate with the introduction of the acetonitrile or transition of the solvent to acetonitrile from the previous composition within the column. In this configuration, the forward pressure regulation subsystem 12 is used to control the pressure in piston pressure chamber 54 in accordance with the column inlet flow pressure of liquid solvent through inlet line 60 as referenced by isolated pressure reference 16 and combined with the adjustable spring load force in the dome (aka bias pressure) of forward pressure regulator 18 to implement movement of the piston at a controlled rate and/or to consolidate the bed 7 to an optimized compression.

The logic and pressure monitoring system controller 70, which communicates with an inlet column pressure sensor 68, may provide actuation to switching valve 50 actuator 72 to define and maintain compression of the bed 7 at desired optimum. More specifically, the beads of bed 7 begin to contract due to the introduction of acetonitrile and, movement is set to the piston to chase the contracting bed (subsystem 12) and, as the contraction of the bed wanes the piston will catch-up and contact the bed and, an increase in pressure above a predetermined level is detected by pressure sensor 68 and, in response, the pressure and monitoring system controller 70 causes the actuator 72 to reconfigure switching valve 50 to change control of pressure regulation in piston chamber 54 to subsystem 14, the operation of which is described in the following.

During various synthesis steps where toluene is used as the solvent (or as described in the previous to define and maintain compression of bed 7 at desired optimum after contraction of bed 7 during various synthesis steps where acetonitrile is used as the solvent), switching valve 50 is configured so that lines 52 and 46 are in communication with one another and lines 22, 36 and 26 are inactive. The piston pressure chamber 54 is then selectively backpressure regulated by spring and dome loaded backpressure regulator 42 (subsystem 14) which communicates exiting hydraulic fluid through line 48 to fluid reservoir 28. Switching of valve 50 to this configuration may be timed to coordinate with the introduction of toluene or (as previously described) to define and maintain compression of the bed 7 at desired optimum after contraction of the bed from an acetonitrile step. In this configuration, the back pressure regulation subsystem 14 is used to control the pressure in piston pressure chamber 54 in accordance with the column outlet flow pressure of liquid solvent through outlet line 66 as referenced by isolated pressure reference 40 and combined with the adjustable spring load force in the dome (aka bias pressure) of back pressure regulator 42 to allow movement of the piston by the expanding beads at a controlled rate and/or to maintain a consolidated bed 7 at an optimized compression when bed expansion or contraction is complete.

Upon changeover to the back pressure regulation subsystem 14, the bed has been consolidated in a previous step by movement of the piston and compression of the bed. The uniform, extremely small beads of the bed 7 will form a cubic pack which (while constrained) will cause the bed to act as a porous solid, transferring the forces of fluid flow to the side walls of the column and thus limiting the upward fluid forces that impinge on the piston. In other words, while the bed is consolidated it acts like a porous plug stuck to the wall of the column. All that is required to maintain the bed consolidated are subtle forces on the piston to maintain constraint on the bed. This subtle force (pressure) is provided by the adjustable spring set in the dome of the backpressure regulator 42 (bias setting). More specifically, the downward forces applied to the piston from chamber 54 are based on the pressure in line 66 plus the bias pressure of backpressure regulator 42. Pressure in line 66 is referenced by the isolated pressure reference 40 and applied to the top of the piston via chamber 54 by the dome load of the backpressure regulator 42 to counter the forces acting on the bottom of piston from external backpressure which may be applied by the fluid flow through the synthesizer. Thus, the subtle forces on the piston to maintain the bed constrained (and thus consolidated) will be applied automatically by the spring and dome loaded back pressure regulator subsystem 14. As the beads in the bed 7 swell from the toluene solvent, the physical forces imparted on the piston will exceed the subtle forces applied by the backpressure regulator bias setting and the piston will move upwards before the bed pushes into the bed support (frit) and plugs the column. The piston will move to accommodate the swelling until the swelling stops and the piston will stop, always maintaining constraint on the bed adequate to maintain consolidation of the bed.

In view of the above, the isolated pressure reference 40 provides the back pressure regulator 42 with a pressure reference at the outlet of the column and the switching valve 50 enables a user to bring in the backpressure regulation using subsystem 14 during the solvent transition to toluene. Back pressure regulation on the piston fluid is all that is necessary during the solvent transition to toluene because the beads 7 are swelling thus applying forces on the piston head 8 in a positive (release) direction.

In view of the above, the piston pressure is thus being regulated by two different means (subsystems 12 and 14) and requires the switching valve 50 to be coordinated with the solvent composition and bed state (swelling/contracting/neutral). Fluctuations in flow rate and/or backpressure are accommodated by the pressure reference feature of both regulators to maintain optimum bed conditions throughout the synthesis. The switching valve 50 is preferably automated via switching valve subsystem 15, as described above, to accomplish the switch between the forward and back pressure regulation subsystems 12 and 14. As an alternative to the switching valve subsystem 15, the system may use a controller configured to receive the solvent flow rate and programmed with the column volume so that it can determine the time it will take for one (or more, or less) column volume(s) of new solvent to enter and displace old solvent, and/or to monitor the pressure in line 60, thus the time or desired compression of the bed to automatically reconfigure the system via switching valve 50. In still another embodiment, the switching valve 50 may simply be operated manually by a user.

An example of the system and method of the invention and their advantages may be seen when NITTOPHASE (HL) is used as the beads in a reactor. The solvent transition step causes NITTOPHASE HL (relatively new polymer technology for oligonucleotide synthesis with 50% increase loading) bead to swell excessively (˜130%). As the bead undergoes this rapid swelling it may cause a devastating pressure rise in the flow through vessel (column) and system shutdown. Prior to the present invention, the only known mitigation was to “pancake” the beads by making a very thin bed and basically punching through (overpowering) the transition layer as it plugs the column momentarily during the solvent transition. This is a tremendous compromise and very expensive (equipment, floor space, handling, etc.) but was the only known way to contain these beads as ‘a consolidated bed throughout synthesis thus optimizing plug flow and guaranteed channel free bed (all necessary for optimized synthesis and yield).

NITTOPHASE is a polymer bead similar in many ways to prior chromatography resins (small, very expensive, specialty applications, etc). It is unique in that its loading capacity is 50% greater than its nearest competitor and that it swells a great deal when exposed to a necessary synthesis step. This excessive swelling creates a technical problem for trying to maintain close pack formation and perfect spheres of the beads. The majority of users avoid these difficulties by synthesizing in a gravity settled vessels where the expansion of the beads is not encumbered by the vessel or bed support. The problem with this method is there is no assurance of uniform exposure, channeling in the vessel may occur (inefficiencies), and excessive solvent and reagent volumes are consumed. If these beads are consolidated into a bed contained in a column (most efficient), the user is faced with major pressure spiking problems during the solvent transition step. The only known remedy is to make the bed so thin (like a pancake) that the momentary plug may be overpowered, as described above. The embodiment of the invention described above eliminates pressure spiking and opens the way for current column users to expand their capacity by 10 to 60 fold with the equipment they currently have and for gravity settled users (and new users) to accomplish high efficiency synthesis in DAC columns. Several new therapies are coming forward whose manufacture will be by NITTOPHASE synthesis. The above embodiment of the present invention thus may bring about a watershed for NITTOPHASE to become much more widely used.

While the preferred embodiments of the invention have been shown and described, it will be apparent to those skilled in the art that changes and modifications may be made therein without departing from the spirit of the invention, the scope of which is defined by the appended claims.

What is claimed is:

1. A system for regulating a pressure of a piston on a bed in a flow through column system, where the flow through column system includes a piston pressure chamber in communication with the piston and an inlet line and an outlet line in communication with the bed, comprising:
a. a supply of hydraulic fluid;
b. a pump having an inlet in communication with the supply of hydraulic fluid and an outlet;
c. a forward pressure reference adapted to communication with the column system inlet line:,
d. a forward pressure regulator having a reference inlet in communication with the forward pressure reference, an inlet in communication with the outlet of the pump and an outlet;
e. a switching valve adapted to communicate with the column system piston pressure chamber, said switching valve also having an inlet in communication with the outlet of the forward pressure regulator and an outlet;
f. a back pressure reference adapted to communicate with the column system outlet line; and
g. a back pressure regulator having an inlet in communication with the outlet of the switching valve, a reference inlet in communication with the back pressure reference and an outlet in communication with the supply of hydraulic fluid;
whereby the switching valve may be manipulated so that a pressure in the column system piston pressure chamber is controlled by either the forward pressure regulator or the back pressure regulator.

2. The system of claim 1 wherein the forward pressure regulator is a dome and spring regulator.

3. The system of claim 1 wherein the back pressure regulator is a dome and spring regulator.

4. The system of claim 1 wherein the forward pressure regulator controls the pressure within the piston pressure chamber so as to provide a bias pressure and a pressure based on the forward pressure reference.

5. The system of claim 4 wherein the back pressure regulator controls the pressure within the piston pressure chamber so as to provide a bias pressure and a pressure based on the back pressure reference.

6. The system of claim 1 wherein the back pressure regulator controls the pressure within the piston pressure chamber so as to provide a bias pressure and a pressure based on the back pressure reference.

7. The system of claim 1 further comprising:
h. a pressure sensor adapted to communication with the column system inlet line;
i. an actuator in communication with the switching valve:
j. a controller in communication with the pressure sensor and the actuator, said controller programmed to manipulate the switching valve so that the back pressure regulator controls pressure in the piston pressure chamber when the pressure sensor detects an increase in pressure above a predetermined level in the inlet line.

8. The system of claim 7 wherein the controller is further programmed to manipulate the switching valve so that the forward pressure regulator controls pressure in the piston pressure chamber when there is an introduction or transition to a solvent that causes the bed to contract.

9. The system of claim 1 wherein the bed is composed of beads.

10. A flow through column system comprising:
a. a column having a bottom plate;
b. a piston movably positioned in the column;
c. a substrate bed positioned in the column between the piston and the bottom plate
d. a piston pressure chamber in communication with the piston;
e. an inlet line and an outlet line in communication with the substrate bed;
f. a supply of hydraulic fluid;
g. a pump having an inlet in communication with the supply of hydraulic fluid and an outlet;
h. a forward pressure reference in communication with the inlet line;
i. a forward pressure regulator having a reference inlet in communication with the forward pressure reference, an inlet in communication with the outlet of the pump and an outlet;
j. a switching valve in communication with the piston pressure chamber, said switching valve also having an inlet in communication with the outlet of the forward pressure regulator and an outlet;
k. a back pressure reference in communication with the outlet line; and
l. a back pressure regulator having an inlet in communication with the outlet of the switching valve, a reference inlet in communication with the back pressure reference and an outlet in communication with the supply of hydraulic fluid;
whereby the switching valve may be manipulated so that a pressure in the column system piston pressure chamber is controlled by either the forward pressure regulator or the back pressure regulator.

11. The system of claim 10 wherein the forward pressure regulator is a dome and spring regulator.

12. The system of claim 10 wherein the back pressure regulator is a dome and spring regulator.

13. The system of claim 10 wherein the forward pressure regulator controls the pressure within the piston pressure chamber so as to provide a bias pressure and a pressure based on the forward pressure reference.

14. The system of claim 13 wherein the back pressure regulator controls the pressure within the piston pressure chamber so as to provide a bias pressure and a pressure based on the back pressure reference.

15. The system of claim 10 wherein the back pressure regulator controls the pressure within the piston pressure chamber so as to provide a bias pressure and a pressure based on the back pressure reference.

16. The system of claim 10 further comprising:
m. a pressure sensor in communication with the column system inlet line;
n. an actuator in communication with the switching valve;
o. a controller in communication with the pressure sensor and the actuator, said controller programmed to manipulate the switching valve so that the back pressure regulator controls pressure in the piston pressure chamber when the pressure sensor detects an increase in pressure above a predetermined level in the inlet line.

17. The system of claim 16 wherein the controller is further programmed to manipulate the switching valve so that the forward pressure regulator controls pressure in the piston pressure chamber when there is an introduction or transition to a solvent that causes the bed to contract.

18. The system of claim 1 wherein the bed is composed of beads.

19. A method for regulating a pressure of a piston on a bed in a flow through column system, where the flow through column system includes a piston pressure chamber in communication with the piston and an inlet line and an outlet line in communication with the bed, comprising the steps of:
a. sensing a back pressure of the outlet line;
b. controlling a pressure in the piston pressure chamber based on the sensed back pressure;
c. determining when the bed has contracted;
d. sensing a forward pressure of the outlet line;
e. controlling a pressure in the piston pressure chamber based on the sensed forward pressure after or when the bed contracts.

20. The method of claim 19 further comprising the steps of:
f. detecting a pressure increase above a predetermined level in the inlet line;
g. controlling a pressure in the piston pressure chamber based on the sensed back pressure after or when the pressure increase above the predetermined level in the inlet line occurs.
